(19) United States
(12) Patent Application Publication
(10) Pub. No.: US 2011/0228895 A1
(43) Pub. Date: Sep. 22, 2011

(54) OPTICALLY DIVERSE CODED APERTURE IMAGING

(75) Inventors: Kevin Dennis Ridley, Malvern (GB); Geoffrey Derek De Villiers, Malvern (GB); Christopher Williams Slinger, Malvern (GB); Malcolm John Alexander Strens, Kenilworth (GB)

(73) Assignee: QINETIQ LIMITED, Farnborough, Hampshire (UK)

(21) Appl. No.: 13/130,914

(22) PCT Filed: Nov. 27, 2009
(86) PCT No.: PCT/GB09/02780

§ 371 Date: May 24, 2011

(30) Foreign Application Priority Data
Dec. 6, 2008 (GB) 0822281.2
Jan. 15, 2009 (GB) 0900580.2

(51) Int. Cl. G01N 23/00

(52) U.S. Cl. 378/2

(57) ABSTRACT

Optically diverse coded aperture imaging (CAI) includes imaging a scene which is multi-spectrally diverse or polarimetrically diverse. A CAI system allows light rays from a scene to pass to a detector array through a coded aperture mask within an optical stop. The mask has multiple apertures, and produces overlapping coded images of the scene on the detector array. Detector array pixels receive and sum intensity contributions from each coded image. The detector array provides output data for processing to reconstruct an image. The mask provides for multi-spectral information to become encoded in the data. A linear integral equation incorporating explicit wavelength dependence relates the imaged scene to the data. This equation is solved by Landweber iteration to derive a multi-spectral image. An image with multiple polarisation states (polarimetric diversity) may be derived similarly with a linear integral equation incorporating explicit polarisation dependence.

This invention relates to optically diverse coded aperture imaging, that is to say imaging with radiation having multiple optical characteristics, such as multiple wavelengths or multiple polarisation states.

Coded aperture imaging is a known imaging technique originally developed for use in high energy imaging, e.g. X-ray or γ-ray imaging where suitable lens materials do not generally exist: see for instance E. Fenimore and T. M. Cannon, “Coded aperture imaging with uniformly redundant arrays”, Applied Optics, Vol. 17, No. 3, pages 337-347, 1 Feb. 1978. It has also been proposed for three dimensional imaging, see for instance “Tomographical imaging using uniformly redundant arrays” Cannon T M, Fenimore E E, Applied Optics 18, no. 7, p. 1052-1057 (1979)

Coded aperture imaging (CAI) exploits pinhole camera principles, but instead of using a single small aperture it employs an array of apertures defined by a coded aperture mask. Each aperture passes an image of a scene to a greyscale detector comprising a two dimensional array of pixels, which consequently receives a diffraction pattern comprising an overlapping series of images not recognisable as an image of the scene. Processing is required to reconstruct an image of the scene from the detector array output by solving an integral equation.

A coded aperture mask may be defined by apparatus displaying a pattern which is the mask, and the mask may be partly or wholly a coded aperture array; i.e. either all or only part of the mask pattern is used as a coded aperture array to provide an image of a scene at a detector. Mask apertures may be physical holes in screening material or may be translucent regions of such material through which radiation may reach a detector.

In a pinhole camera, images free from chromatic aberration are formed at all distances away from the pinhole, allowing the prospect of more compact imaging systems, with larger depth of field. However, a pinhole camera suffers from poor intensity throughput, the pinhole having small light gathering characteristics. CAI uses an array of pinholes to increase light throughput

In conventional CAI, light from each point in a scene within a field of regard casts a respective shadow of the coded aperture on to the detector array. The detector array therefore receives multiple shadows and each detector pixel measures a sum of the intensities falling upon it. The coded aperture is designed to have an autocorrelation function which is sharp with very low sidelobes. A pseudorandom or uniformly redundant array may be used where correlation of the detector intensity pattern with the coded aperture mask pattern can yield a good approximation (Fenimore et al. above).

In “Coded aperture imaging with multiple measurements” J. Opt. Soc. Am. A, Vol. 14, No. 5, May 1997 Busboom et al. propose a coded aperture imaging technique which takes multiple measurements of the scene, each acquired with a different coded aperture array. They discuss image reconstruction being performed using a cross correlation technique and, considering quantum noise of the source, the choice of arrays that maximise the signal to noise ratio.

International Patent Application No. WO 2006/125975 discloses a reconfigurable coded aperture imager having a reconfigurable coded aperture mask means. The use of a reconfigurable coded aperture mask in an imaging system allows different coded aperture masks to be displayed at different times. It permits the imaging system's resolution, direction and field of view to be altered without requiring moving parts.

A greyscale detector array used in conjunction with a coded aperture produces output data which is related to an imaged scene by a linear integral equation: for monochromatic radiation, the equation is a convolution equation which can be solved by prior art methods which rely on Fourier transformation. However, the equation is not a convolution equation for optically diverse coded aperture imaging such as that involving polychromatic (multi-wavelength) radiation, and so deconvolution via Fourier transformation does not solve it.

It is an object of the present invention to provide a coded aperture imaging technique for optically diverse imaging.

The present invention provides a method of forming an image from radiation from an optically diverse scene by coded aperture imaging, the method incorporating:
a) arranging a coded aperture mask to image radiation from the scene on to detecting means to provide output data in which optically diverse information is encoded,
b) processing the output data from the detecting means by representing the data in a linear integral equation which explicitly contains optical diversity dependence, and
c) solving the linear integral equation as a function of position and optical diversity over the scene to reconstruct an image.

The invention provides the advantage that it enables more complex scenes to be imaged using coded aperture imaging, i.e. scenes such as those which are multi-spectrally diverse or polarimetrically diverse. It is not restricted to monochromatic radiation for example.

The optically diverse scene may be multi-spectrally diverse and the linear integral equation may be

$$g ( y ) = {\int }_{{λ}_{1}}^{{λ}_{2}} {\int }_{a}^{b} K ( λ , x - y ) f ( λ , x ) d λ d x .$$

The optically diverse scene may be polarimetrically diverse and the linear integral equation may be

$$g ( y ) = {\sum }_{i = 1}^{2} {\int }_{a}^{b} {K}_{i} ( y - x ) {f}_{i} ( x ) d x .$$

The coded aperture mask may have apertures with a first polarisation and other apertures with a second polarisation, the first and second polarisations being mutually orthogonal.

The step of solving the linear integral equation may be Landweber iteration.

The method of the invention may include using a quarter-wave plate to enable the data output by the detecting means to incorporate circular polarisation information.

A converging optical arrangement such as a lens may be used to focus radiation from the optically diverse scene either upon or close to the detecting means. This increases signal-to-noise ratio compared to conventional coded aperture imaging, and allows faster processing of the detector array output. The lens may be between the coded aperture mask and the detecting means, or the mask may be between the lens and the detecting means.

In another aspect, the present invention provides a coded aperture imaging system for forming an image from radiation from an optically diverse scene, the system having:
a) a coded aperture mask to image radiation from the scene on to detecting means to provide output data in which optically diverse information is encoded,
b) digital processing means for:
   i) processing the output data from the detecting means by representing the data in a linear integral equation which explicitly contains optical diversity dependence, and
   ii) solving the linear integral equation as a function of position and optical diversity over the scene to reconstruct an image.

In a further aspect, the present invention provides a computer software product comprising a computer readable medium incorporating instructions for use in processing data in which optically diverse information is encoded, the data having been output by detecting means in response to a radiation image obtained from an optically diverse scene by coded aperture imaging, and the instructions being for controlling computer apparatus to:
a) process the output data from the detecting means by representing the data in a linear integral equation which explicitly contains optical diversity dependence, and
b) solve the linear integral equation as a function of position and optical diversity over the scene to reconstruct an image.

The coded aperture imaging system and computer software product aspects of the invention may have preferred but not essential features equivalent mutatis mutandis to those of the method aspect.

The invention will now be described, by way of example only, with reference to the accompanying drawings, in which:

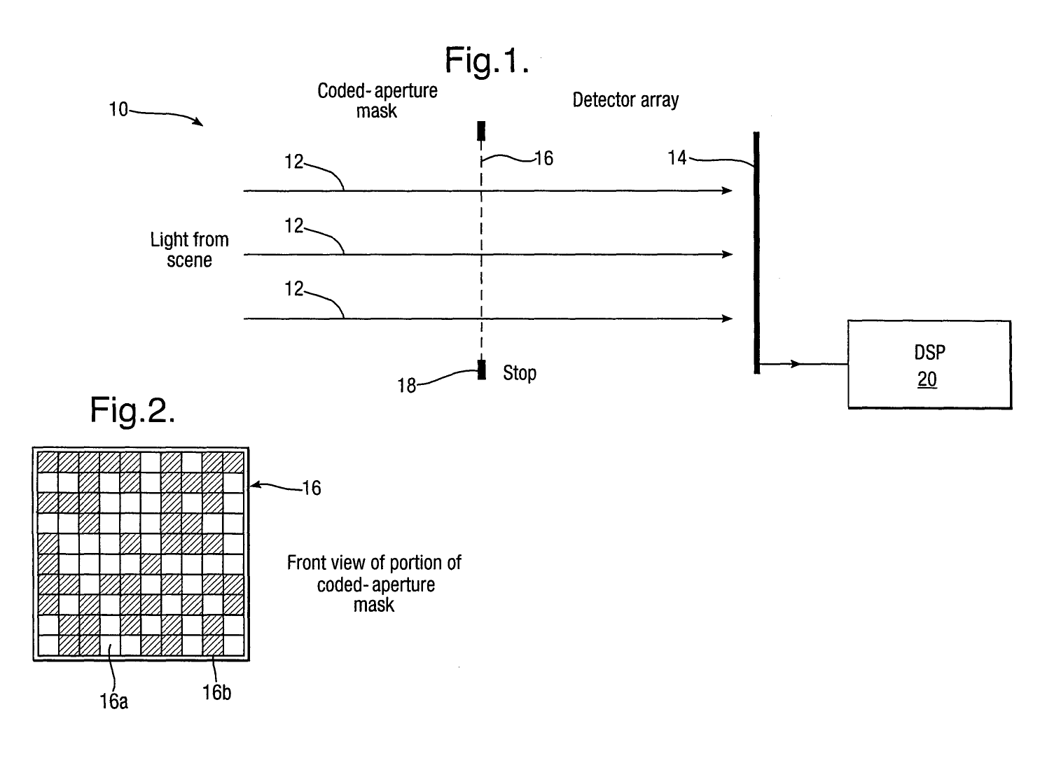

FIG. 1 is a schematic side view of a coded aperture imaging system of the invention;

FIG. 2 is a schematic plan view of a coded aperture mask incorporated in FIG. 1 for use in multi-spectral imaging;

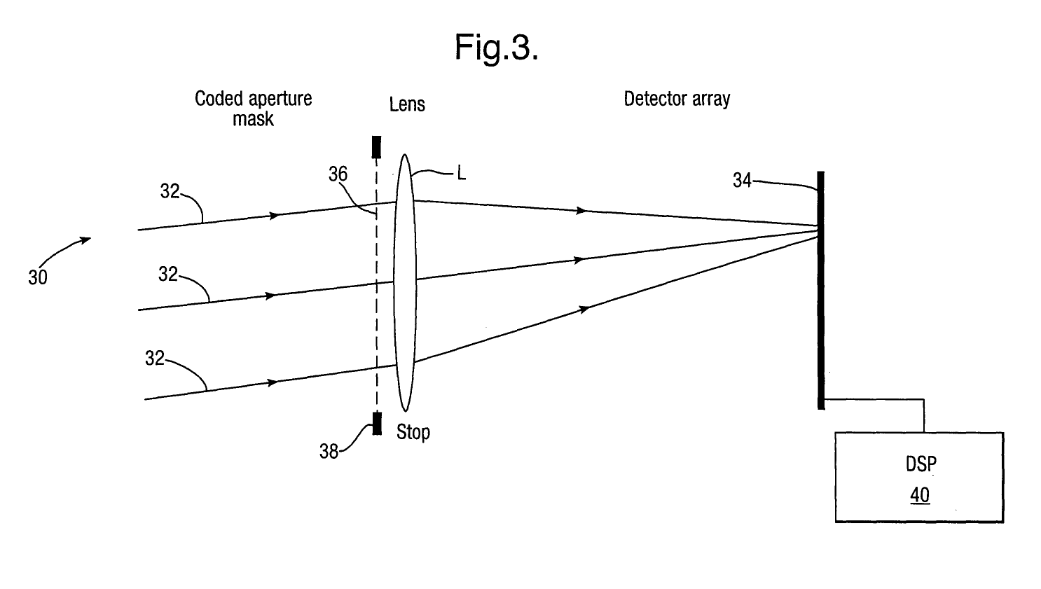

FIG. 3 is a schematic side view of a coded aperture imaging system of the invention which includes a lens;

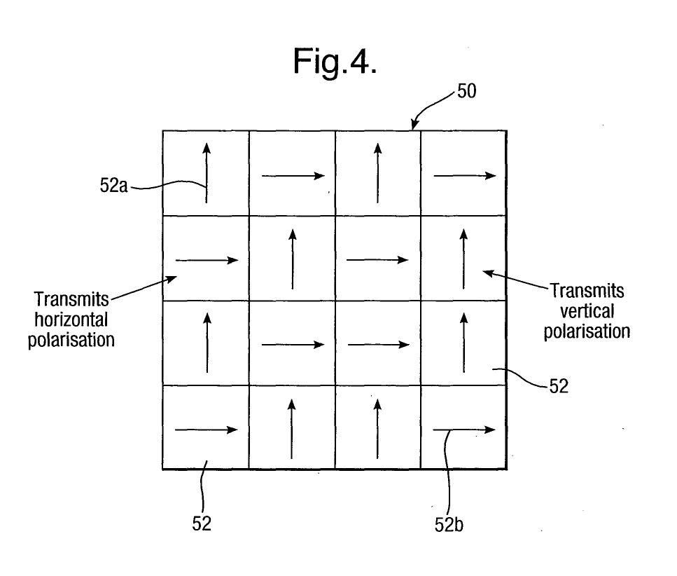

FIG. 4 is a schematic plan view of a coded aperture mask for use in polarimetric imaging;

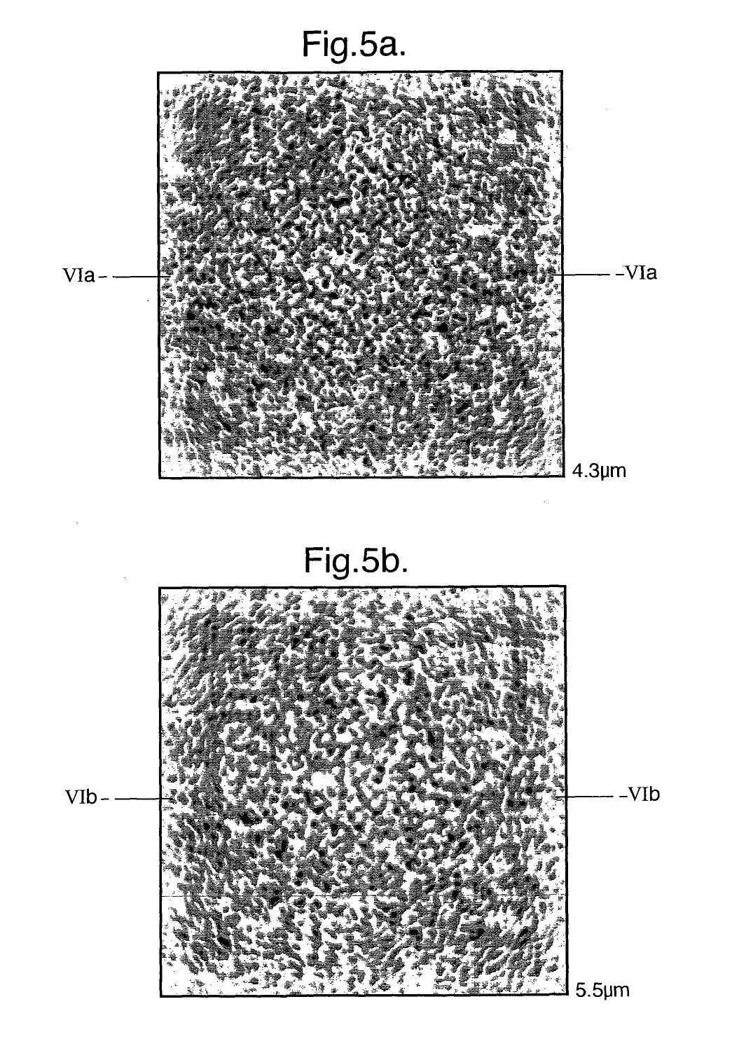

FIG. 5 shows modelled diffraction patterns (a) and (b) produced by the FIG. 1 system at a detector array for radiation wavelengths of 4.3 μm and 5.5 μm;

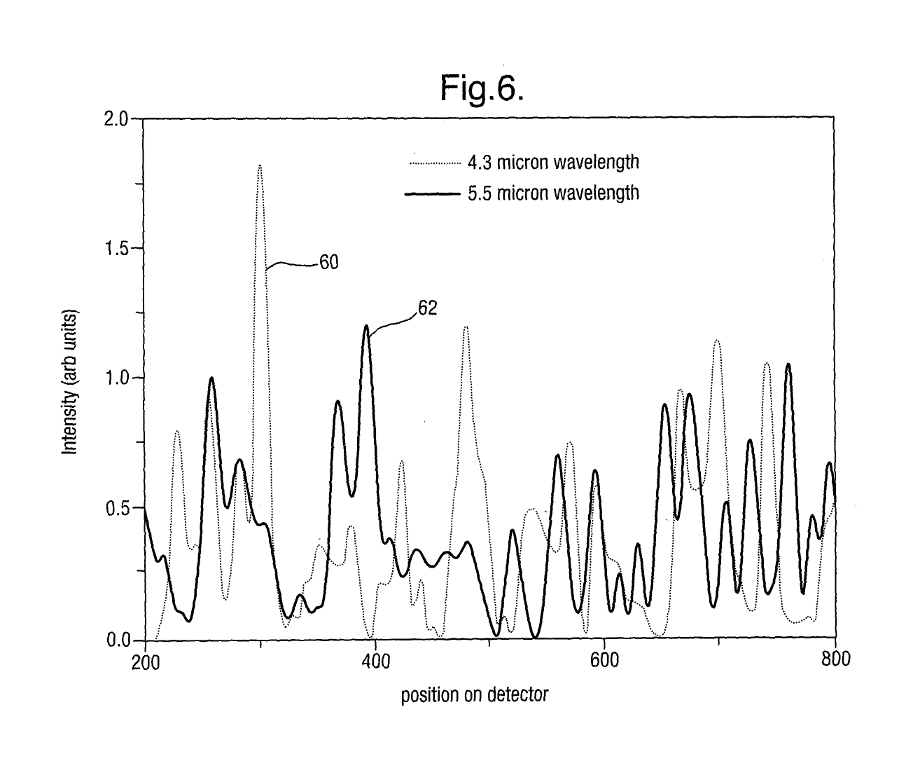

FIG. 6 shows radiation intensity along lines VIa-VIa and VIb-VIb in FIG. 5 (a) and (b) respectively;

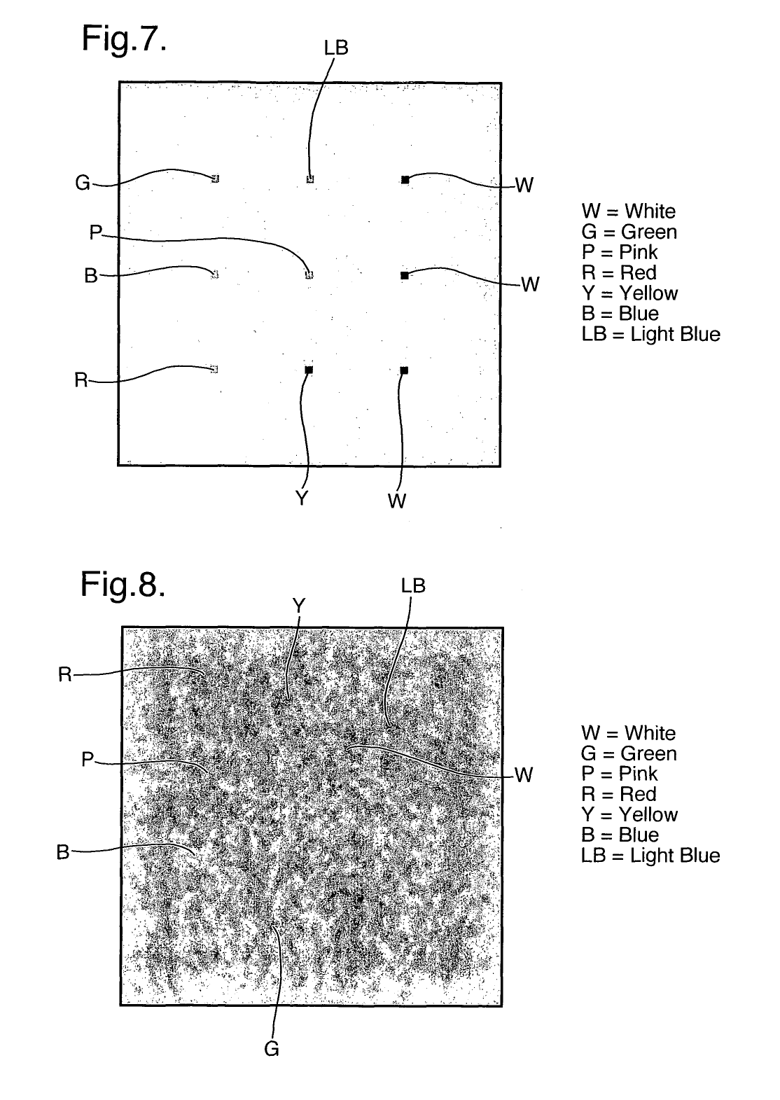

FIG. 7 illustrates a multi-spectral scene comprising a three by three array of point sources with single and multiple wavelengths used to model operation of the invention;

FIG. 8 illustrates a diffraction pattern caused by a coded aperture mask acting on the sources of FIG. 7;

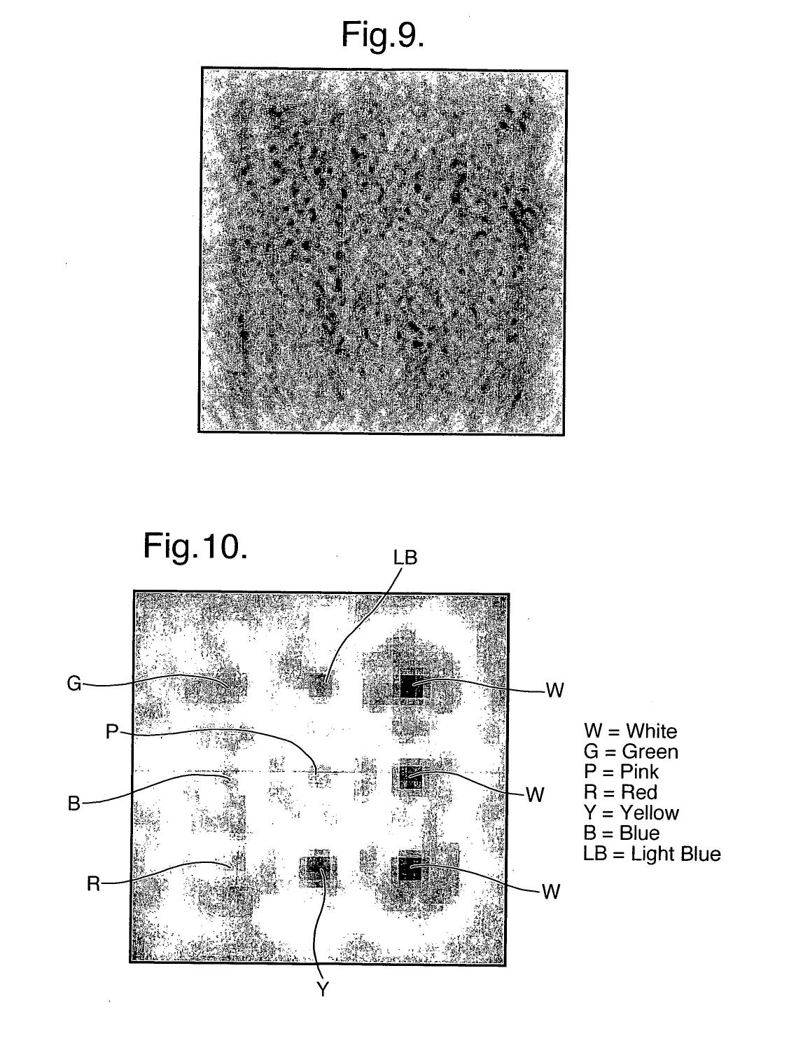

FIG. 9 shows a detector array output corresponding to the FIG. 8 diffraction pattern;

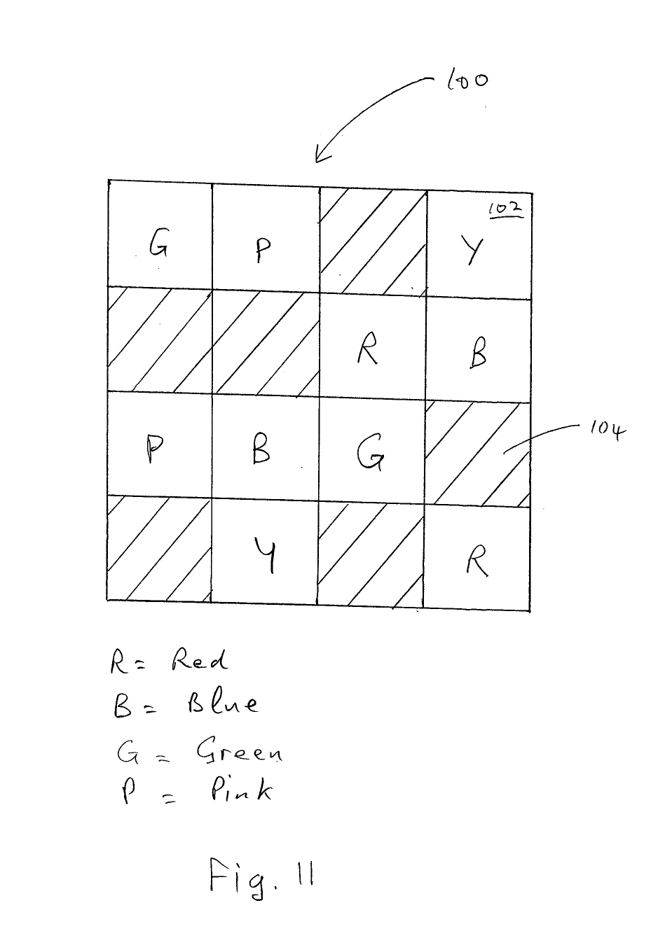

FIG. 10 is an estimate of the multi-spectral scene of FIG. 7 obtained by processing the FIG. 9 detector array output; and

FIG. 11 illustrates a spectrally selective mask.

In this specification, the expression “optically diverse” and associated expressions in relation to radiation from an imaged scene or object will be used to indicate that such radiation has multiple optical characteristics, such as multiple wavelengths or multiple polarisation states. Moreover, the expression “scene” will include any scene or object which is imaged by coded aperture imaging (CAI).

Referring to FIG. 1, a CAI system is indicated generally by 10. Rays of light indicated by arrowed lines 12 pass to the right from points in a scene (not shown) to a detector array 14 of pixels (not shown) through a coded aperture mask 16 within an optical stop 18. The detector array develops an output which is digitised and processed by a digital signal processing (DSP) unit 20 to develop an image of the scene.

Referring now also to FIG. 2, the structure of the coded aperture mask 16 is indicated by a ten by ten array of squares, of which white squares such as 16a indicate translucent apertures and shaded squares such as 16b indicate opaque regions. FIG. 2 corresponds to a magnified view of part of a mask, because in practice such a mask has more than 100 apertures. The apertures 16a and opaque regions 16b are randomly distributed over the mask 16. The mask 16 acts as a shadow mask: when illuminated by a scene, the mask 16 causes a series of overlapping coded images to be produced on the detector array 14. Each pixel of the detector array 14 receives contributions of light intensity from each of the coded images, and sums its respective contributions.

Referring to FIG. 3, a modified version of the CAI system 10 is indicated generally by 30. Parts equivalent to those described with reference to FIG. 1 are like-referenced with the addition of 20. The modified version 30 is largely as previously described except that it includes a converging lens L to focus light from a mask 36 on to a detector array 34, and would employ fewer and bigger mask apertures. As illustrated, the lens L is between the mask/stop combination 36/38 and detector array 34, but close to the mask: i.e. the distance from the mask to the lens centre is 6.5% of the mask-detector array separation. This is just one of a number of possible configurations: the mask 36 may be more remote from the lens L; it may be positioned between the lens L and the detector array 34; the lens L may focus the rays 32 either on to the detector array 34 or at a point which is a short distance from the detector array 34. Multiple lenses and/or mirrors in converging optical arrangements could also be used instead of the lens L. Use of a lens or other converging optical arrangement in conjunction with a mask 36 greatly increases signal-to-noise ratio compared to conventional CAI, which does not use such a lens or arrangement. In addition, it has potential for reducing the computational load of processing the detector array output, because the algorithms used in such processing can operate just over regions of interest in the scene instead of over the whole scene. The lens L (or other converging optics) also makes it possible to have fewer mask apertures compared to the non-lensed equivalent shown in FIG. 1, preferably 64 or more apertures, but results have been obtained with as few as 16 apertures.

In FIG. 4, an alternative form of mask 50 is shown which is for discrimination between two orthogonal linear polarisation states of radiation: i.e. it is for use with a scene which is optically diverse in terms of multiple polarisation states. The mask 50 is a four by four array of square apertures such as 52, each aperture containing an arrow indicating a polarisation of light which it transmits: i.e. a vertical arrow such as 52a indicates an aperture 52 which transmits vertically polarised light and a horizontal arrow such as 52b indicates a square 52 which transmits horizontally polarised light. The mask 50 has two upper rows and two left hand side columns of apertures 52 along which transmission alternates between horizontal and vertical polarisation. The mask 50 has two lower rows and two right hand side columns of apertures 52 in which two apertures transmitting the same polarisation (i.e. both horizontal or both vertical) are arranged between two apertures transmitting the other polarisation (i.e. both vertical or both horizontal respectively).

The mask 50 modulates light incident upon it according to the light's polarisation state. In optics, a point spread function (PSF) is a useful quantity for characterising an imaging system: a PSF is defined as a pattern of light produced on a detector array in an optical system by a point of light located in a scene being observed by the system. The PSF of a CAI system containing a mask 50 changes according to the polarisation state of light incident upon the mask. Knowledge of the PSF for each polarisation state allows polarisation information for elements of a scene to be obtained by processing the CAI system's detector array output. This enables the CAI system to determine the degree of linear polarisation for points in a scene. The system's detector array receives a super-position of data for each polarisation state. For the mask 50 there are two polarisation states which are orthogonal to one another, and consequently their super-position results in a simple addition of intensities. This is the optimum situation: if they were not orthogonal the super-position would not be a simple addition of intensities and the decoding process would be more difficult.

A further option is to place a quarter-wave plate (not shown) in front of the mask 50, with its optical axis angle at 45 degrees to the horizontal and vertical polariser axes: this would enable the CAI imager to detect circular polarisation for points in a scene.

The mask 50 with or without quarter-wave plate may be used with the CAI system 10 or 30. In a geometric-optics regime the CAI system 10 would not work very well because an unpolarised scene would not be modulated at all, merely attenuated by 50%. However, when diffraction is significant there will be modulation because of interference between light that has gone through different apertures 16a. A diffraction regime exists when λz/a² is much greater than 1, where λ is the light's wavelength, α is mask aperture diameter and z is mask to detector distance. Some mask apertures 52 may be opaque to increase modulation of intensity recorded by the detector array 14 or 34, or to make patterns for different polarisation states more linearly independent.

A mask similar to the mask 50 may also be designed for spectral discrimination: such a mask would have spectrally selective apertures (i.e. optical band-pass filters) instead of polarisation selective apertures.

Referring to FIG. 1 once more, an analysis of the operation of the CAI system 10 was carried out by computer modelling at radiation wavelengths of 4.3 μm and 5.5 μm. The system 10 uses diffractive effects from the mask 16 to code light from a scene prior to detection, and consequently a diffraction pattern of known kind is cast on to the detector array 14 from each point in a scene: this diffraction pattern can be used to recover an image of the scene. The diffraction pattern varies as a function of the wavelength of light received from the scene. Therefore, through appropriate digital processing, it is possible to recover spectral information about the distribution of wavelengths of points in the scene. Such information has many uses in automatic processing of the scene (computer vision) or for presentation to a human operator: for example, it can help to discriminate between objects or surfaces in the scene that have the same intensity but differ spectrally.

Referring now to FIG. 5, (a) and (b) are computer modelled diffraction patterns for radiation wavelengths of 4.3 μm and 5.5 μm appearing in a detector, array location, in this case a plane 10 cm from a mask: in both (a) and (b), radiation intensity is indicated by degree of darkness, so light colouration is low intensity and dark colouration is high intensity. The radiation to which FIG. 5 corresponds is optically diverse because it has two wavelengths. The diffraction patterns were calculated for a 6.4 mm square random coded mask with 80 μm apertures, the mask being illuminated by point sources that were identical except for their differing wavelengths. The patterns were sampled at 6.67 μm intervals. Each of the diffraction patterns (a) and (b) has a broad spread and considerable spatial structure, and they are different to one another.

FIG. 6 shows radiation intensity curves 60 and 62 taken along respective horizontal lines VIa-VIa and VIb-VIb through the centres of the diffraction patterns (a) and (b) of FIG. 5, curve 60 for pattern (a) and 4.3 μm being dotted and curve 62 for pattern (b) and 5.5 μm being solid. In this drawing, intensity in arbitrary units is plotted against pixel position on the detector array 14. There are major differences between the diffraction patterns (a) and (b) due to their differing wavelengths: this demonstrates that a CAI diffraction pattern, when measured at a detector, conveys information about wavelength distribution (spectrum) of surfaces in a scene. Therefore spectral information is obtainable using a greyscale detector, i.e. without the use of a multi-spectral detector to separate contributions at different wavelengths. This is an example of the use of scalar diffraction i.e. the diffraction pattern is independent of the polarisation of light falling on the mask.

As feature sizes in a mask are decreased (typically to wavelength scales) and appropriate mask aperture patterns are used, then vector diffraction regimes become important: in such regimes, the polarisation of light incident on the mask influences the diffraction pattern produced. So CAI diffraction patterns convey information about both wavelength and polarisation of light from a scene.

The processing required to form an image is related to conventional CAI processing in that it requires the solution of a linear inverse problem (see Bertero M and Boccacci P, Introduction to Inverse Problems in Imaging, IoP Publishing, 1998, hereinafter “Bertero and Boccacci”). Techniques for this type of problem include Tikhonov regularisation and Landweber iteration. However, the dimensionality of the information to be inferred is increased unless additional regularisation constraints are applied: for example, exploiting (i) correlations in spectral signature of objects/surfaces (e.g. blackbody curves), or (ii) spatial structure in spectral information. If strong prior knowledge regarding spectra is available then spectrally sensitive processing may out-perform conventional processing in terms of spatial resolution even if it provides a greyscale image as an end product: this is because it does not make the incorrect assumption that the scene consists of only a single spectrum (plus noise).

Computer modelled diffraction patterns were used to predict the detector array signal generated by the CAI system 10 in response to light from a multi-spectral scene, i.e. having optical diversity in wavelength. The mask dimensions were the same as those used to generate FIGS. 5 and 6. The scene was assumed to be that shown in FIG. 7, i.e. an equispaced three by three square array of nine point sources indicated by small squares W, G, P, R, Y, B and LB: the sources have a spacing corresponding to 0.534 mrad in terms of the angle subtended at the mask by the points in the scene. Each of the sources W to LB contains either one wavelength or a mixture of wavelengths from a set of three possible wavelengths: in FIG. 7 these wavelengths have been assigned red, green and blue colours, and additive mixtures of these, although the actual wavelengths are in the infra-red part of the spectrum and are invisible to the human eye. The nine point sources W, G, P, R, Y, B and LB represent white, green, pink, red, yellow, blue and light blue respectively.

Diffraction effects at the three wavelengths differ, and give rise to differing incident radiation at the detector array 14 as shown in FIG. 8. Each colour gives rise to a diffraction pattern distributed over the whole of the detector array 14, so multiple colours are superimposed upon one another: positions of some points of colour are indicated at W, G, P, R, Y, B and LB, but each colour is not restricted to the associated indicated point. The detector array 14 is greyscale, and each pixel simply sums the intensity contributions it receives at the three wavelengths. There is also detector noise, and consequently the detector array output is a degraded signal shown in FIG. 9, in which radiation intensity is indicated by degree of darkness as in FIG. 5. The detector array output signal was processed to provide an estimate of the multi-spectral scene shown in FIG. 10, which by comparison with FIG. 7 shows good recovery of both monochromatic spectra R, B and G and mixed spectra W, LB, P and Y has been obtained. These results were obtained at a peak signal to noise ratio of 10.

The processing of multi-spectral data is described below, and it also applies to multi-polarisation data, i.e. data with polarisation diversity. The invention allows a CAI system to gather spectral and/or polarisation information from a scene being imaged, from a single acquired frame of detector data, without significant modification to the CAI optics 10 other than a polarisation discrimination mask 50.

The greyscale detector array 14 produces output data denoted by g(y) in response to a multi-spectral CAI image of a scene or object denoted by f(λ,x), where λ is optical wavelength assumed to lie between limits λ₁ and λ₂, and x and y are two-dimensional variables. The detector array output data g(y) is processed as follows: it is related to the scene via a linear integral equation of the form:

$$g ( y ) = {\int }_{{λ}_{1}}^{{λ}_{2}} {\int }_{a}^{b} K ( λ , x - y ) f ( λ , x ) d λ d x \qquad ( 1 )$$

where K(λ,x) is a point spread function of the CAI system 10 for monochromatic radiation of wavelength 2. It is assumed that the detector array output data g(y) includes additive noise; a and b are suitable limits for the integral over x which may or may not be infinite.

For monochromatic radiation λ₁=λ₂=λ and b=−a=∞, and Equation (1) reduces to a convolution equation; but Equation (1) is not a convolution equation for polychromatic (multi-wavelength) radiation. Hence it is not possible to use prior art methods which rely on Fourier transforming both sides of Equation (1) in order to solve it. In addition, finite limits a and b will be used.

Rewriting Equation (1) in operator notation:

g=Kf (2)

It is now assumed that the detector array output data g and object or scene f being imaged lie in respective Hilbert spaces G and F. The operator K is approximated by a matrix with matrix elements having two indices: one of these indices is a combined (λ, x) index representing a sufficiently fine sampling of λ and x which are continuous variables. Here sufficiently fine sampling means that the problem to be solved is not discernibly altered as a result of the sampling. The other matrix element index represents a sufficiently fine sampling of variable y, in practice given by pixel number on the detector array 14.

The solution to Equation (2) can be expressed as a least-squares problem: i.e. to minimise over f a discrepancy functional ε²(f) given by:—

ε²(f)=∥Kf−g∥² (3)

The solution f to this minimisation problem will satisfy a normal equation as follows:

K*Kf=K*g (4)

where K* is an adjoint operator to K, defined by scalar products <,> in the Hilbert spaces F and G by:

[symbol]

h,Kl [symbol] _{G}= [symbol] K*h,l [symbol] _{F} (5)

for all hεG and lεF. There is a method for solving Equation (1) referred to as “Landweber” and involving an iteration of the form:

fₙ₊₁=fₙ+τ(K*g−K*Kfₙ) (6)

The Equation (6) iteration employs a suitably chosen initial value of fₙ denoted by f₀; τ is a parameter which satisfies:

$$0 < τ < \frac{2}{{σ}_{1}^{2}} \qquad ( 7 )$$

where the operator K has a set of singular values of which σ₁ is the largest.

In the presence of noise on the detector array output data g, the Equation (6) iteration is not guaranteed to converge: the iteration is therefore truncated at a point which depends on the noise level. Further details on the Landweber method can be found in Bertero and Boccacci.

There are alternative methods for solving Equation (1) such as a truncated singular function method and Tikhonov regularisation. The details of these methods may also be found in Bertero and Boccacci.

The polarimetric imaging problem is specified by an equation of the form:

$$g ( y ) = {\sum }_{i = 1}^{2} {\int }_{a}^{b} {K}_{i} ( y - x ) {f}_{i} ( x ) d x \qquad ( 8 )$$

In Equation (8), i is an index representing the two polarisation states (horizontal and vertical polarisation) transmitted by the mask 50.

As before, Equation (8) is written in operator notation as:

g=Kf (9)

It is now assumed that the detector array output data g and scene f being imaged lie in respective Hilbert spaces G and F. The operator K is approximated by a matrix with matrix elements having two indices: one of these indices is a combined (i, x) index representing a sufficiently fine sampling of x which is a continuous variable. The other matrix element index represents a sufficiently fine sampling of variable y, in practice given by pixel position on the detector array 14.

Equation (9) may again be solved using Landweber iteration. The Landweber iteration used is of the same form as that for the multi-spectral imaging problem, with the same constraints on the parameter τ.

Equation (9) may also be solved using various other methods from the theory of linear inverse problems, including Tikhonov regularisation and the truncated singular function expansion solution (again see Bertero and Boccacci).

Although data is recorded on a greyscale detector array 14 or 34, the invention uses a mask 16 or 36 to ensure that optically diverse information, i.e. multi-spectral and/or polarimetric information, is not lost, but instead becomes encoded in the data. For both multi-spectral and polarimetric imaging, the relationship between the scene being imaged and the recorded data is represented by a linear integral equation. By writing the wavelength or polarisation state dependence (optically diversity dependence) explicitly in the integral equation it is possible to solve this equation in terms of a function of position within the scene and wavelength content and/or polarisation state. The preferred method of solution is known as Landweber iteration, though various other methods may also be employed. Since these methods are known in the prior art they will not be described further.

Referring now to FIG. 11, a spectrally selective coded aperture mask 100 is shown schematically which is for use in a multi-spectral embodiment of the invention. The mask 100 has apertures such as 102 with different transmission wavelength characteristics. The mask 100 is an array of colour filters interspersed with opaque apertures such as 104 shown cross-hatched. Apertures which are labelled R, B, G, or P transmit red, blue, green or pink light respectively. The mask 100 is used with a lens, as shown in FIG. 3, and light which it transmits is focused on to a monochrome camera.

1-11. (canceled)

12. A method of forming an image from radiation from an optically diverse scene by coded aperture imaging, the method incorporating:
a) arranging a coded aperture mask to image radiation from the scene on to detecting means to provide output data in which optically diverse information is encoded,
b) processing the output data from the detecting means by representing the data in a linear integral equation which explicitly contains optical diversity dependence, and
c) solving the linear integral equation as a function of position and optical diversity over the scene to reconstruct an image.

13. A method according to claim 12 wherein the optically diverse scene is at least one of multi-spectrally diverse and polarimetrically diverse.

14. A method according to claim 13 wherein the optically diverse scene is multi-spectrally diverse and the linear integral equation is:
$$g ( y ) = {\int }_{{λ}_{1}}^{{λ}_{2}} {\int }_{a}^{b} K ( λ , x - y ) f ( λ , x ) d λ d x .$$

15. A method according to claim 13 wherein the optically diverse scene is polarimetrically diverse and the linear integral equation is:
$$g ( y ) = {\sum }_{i = 1}^{2} {\int }_{a}^{b} {K}_{i} ( y - x ) {f}_{i} ( x ) d x .$$

16. A method according to claim 14 wherein the step of solving the linear integral equation is Landweber iteration.

17. A method according to claim 15 wherein the step of solving the linear integral equation is Landweber iteration.

18. A method according to claim 13 wherein the optically diverse scene is polarimetrically diverse and the coded aperture mask has apertures with a first polarisation and other apertures with a second polarisation, the first and second polarisations being mutually orthogonal.

19. A method according to claim 18 including using a quarter-wave plate to enable the data output by the detecting means to incorporate circular polarization information.

20. A method according to claim 12 including using a converging optical arrangement to focus the radiation from the optically diverse scene either upon or close to the detecting means.

21. A method according to claim 16 wherein the converging optical arrangement is a converging lens and either the lens is between the coded aperture mask and the detecting means, or the mask is positioned between the lens and the detecting means.

22. A method according to claim 17 wherein the converging optical arrangement is a converging lens and either the lens is between the coded aperture mask and the detecting means, or the mask is positioned between the lens and the detecting means.

23. A coded aperture imaging system for forming an image from radiation from an optically diverse scene, the system having:
a) a coded aperture mask to image radiation from the scene on to detecting means to provide output data in which optically diverse information is encoded,
b) digital processing means for:
i. processing the output data from the detecting means by representing the data in a linear integral equation which explicitly contains optical diversity dependence, and
ii. solving the linear integral equation as a function of position and optical diversity over the scene to reconstruct an image.

24. A computer software product comprising a computer readable medium incorporating instructions for use in processing data in which optically diverse information is encoded, the data having been output by detecting means in response to a radiation image obtained from an optically diverse scene by coded aperture imaging, and the instructions being for controlling computer apparatus to:
a) process the output data from the detecting means by representing the data in a linear integral equation which explicitly contains optical diversity dependence, and
b) solve the linear integral equation as a function of position and optical diversity over the scene to reconstruct an image.
